(19) United States
(12) Patent Application Publication
(10) Pub. No.: US 2010/0066826 A1
(43) Pub. Date: Mar. 18, 2010

(54) OPTICAL METHOD AND MEASURING DEVICE FOR A WEB CONTAINING FIBERS

(76) Inventor: Rudolf Munch, Konigsbronn (DE)

Correspondence Address: TAYLOR & AUST, P.C., P.O. Box 560, 142. S Main Street, Avilla, IN, 46710, US

(21) Appl. No.: 12/406,675

(22) Filed: Mar. 18, 2009

(30) Foreign Application Priority Data
Mar. 19, 2008 (DE) 10 2008 000 774.9

(51) Int. Cl. H04N 7/18

(52) U.S. Cl. 348/135; 348/E07.085

(57) ABSTRACT

The present invention relates to a method for the optical recording and evaluation of characteristic properties, for example, faults in appearance, of moving web containing fibers, for example, cellulose fibers. The method for the present invention uses at least the following components: a light of a light source and a video signal generated by a light-sensitive sensor, for example, a video camera, whereby the light source and the light-sensitive sensor form a measurement system, and an evaluation system. The light source has two lights, a first light with a first color and a second light with a second color different to the first, which interact with the web containing fibers. The at least one light-sensitive sensor generates the video signal from parts of the first and second light which are received by it, such that the evaluation system can determine from the signal the characteristic properties of the web containing fibers.

### BACKGROUND OF THE INVENTION

1. Field of the Invention

The present invention relates to a method and a measuring device for the optical recording and evaluation of characteristic properties, for example, faults in appearance, of a moving web containing fibers.

2. Description of the Related Art

The market, in particular for mass-produced printing paper, calls at the international level of competition for a high standard of quality that is perceivable to the users of the paper. An important parameter in this connection is calender blackening.

Calendering denotes, as is generally known, the smoothing of a paper's surface in a calender, which is an apparatus such as a roll for the smoothing of paper. As a result of the calendering, for example, under pressure and at high temperature, the paper acquires a certain surface characteristic which, on the one hand is desirable, for example, as great a smoothness as possible, but on the other hand, undesirable, for example, blackening.

In the article “Einfluss der Papierzusammensetzung auf die Schwarzsatinage von SC-Papier” [English translation of title: Influence of Paper Composition on the Calender Blackening of SC Paper] by H. Praast, A. Schmidt, S. Holzhey and L. Göttsching in the journal “Das Papier”, issue ipw September 2001, it is explained that SC paper (SC=super-calendered) is inclined to become transparent predominantly at fiber crossover points. These regions, intensified by the printing process, appear dark in impinging light and lend the paper a gray appearance. This cumulative optical effect is referred to as calender blackening or simply blackening.

In particular, optical measuring devices are traditionally used to record measurement variables. As such, methods for monitoring paper and paperboard webs, in particular methods for monitoring blackening with the help of optical or light-sensitive sensors such as CCD sensors or CCD cameras (CCD=Charge Coupled Device), are known in principle as will be shown in the following. As a rule, the data flow from the light sensors after the recording is evaluated or analyzed with the help of an evaluation system, for example, by means of digital signal processors or with the help of software-supported image analysis.

Described in U.S. Pat. No. 5,389,789, is, for example, a portable tear detector for detecting the size and shape of a tear in a paper web on a paper machine, the detector having a plurality of light sources and light sensors. The light sensors can receive the light from the light sources which passes through a tear. Size and shape of the tear are determined by means of a processor and so-called digital signal processing, which are compatible with a personal computer. Light guides and infrared sensors are used.

U.S. Pat. No. 4,931,657 describes an optical system for the online recording of a web's textures, and it describes texture sensors, which carry out an image analysis on video signals, which are momentarily produced by a video camera, whereby the video camera works in sync with the light of a stroboscope. A formation tester described in this publication works with impinging light while a dirt counter works with transmitted light.

Described in US 2002/0100569 A1 are a system and a method for measuring paper formation properties in real time. Light is transmitted from a light source onto the surface of a wet paper web and is reflected from the surface to a camera. An image corresponding to the reflected light is created and data derived from the image can be compared with other process parameters in order to provide a feedback loop for adjusting the parameters of the paper production process in real time.

The purpose of the optical measurements and the image analysis is to enable the quantification and localization of optically recordable parameters such as blackening, and thus, enable the controlled correction of faults. The previously quoted article also describes a PC-based image analysis system for the recording of blackening, which uses a camera with a macro-lens to record an unprinted paper specimen illuminated by impinging light, on a black background with a measuring area of around 10 mm by 10 mm.

A drawback of the prior art mentioned up to now, and in particular of the measurement system described in the previously quoted article, is that faults in the appearance of a paper web which, like blackening, are based on transparency effects, meaning changes of opacity, or on spots caused by drops of liquid, cannot be clearly diagnosed using only one type of light. Namely, in the case of blackening, a dark fiber and a semi-transparent fiber indicative of blackening are practically identical in impinging light. Another drawback of the prior art described in the article is that the measurement system in question is suitable only for research and laboratory purposes and cannot be used for real-time recording in production mode.

EP 1 749 930 A1 describes a device for treating a fibrous web, in particular a paper web or paperboard web, with a calender having at least one nip through which the web runs, and with a sensor arrangement having a preferably optical blackening sensor with light-sensitive elements and a light source, with whose help the blackening can be recorded online, meaning directly during production, preferably without contact. The light source, for example, a flashlight or stroboscope light, shines on the web and emits light with a wave length at which the light-sensitive elements display their greatest sensitivity. This is, for example, light in the near infrared spectrum, for example 830 nm, i.e. the spectral line of semiconductor lasers, whereby it would be possible to use CCD sensors which display their greatest sensitivity in this spectrum.

According to EP 1 749 930 A1, the signal of the blackening sensor can be used to tell a production control system which region of the web is faulty. The light source and the light-sensitive elements are arranged on the same side of the web, in which case it is determined how much light is reflected from the surface of the web. It is favorable for a dark object, preferably a roll, to be arranged on the side of web opposite that of the light-sensitive elements, the object reflecting any light rays far more poorly than the upper side of the web against which the light source is directed. The sensitivity of the blackening sensor is thus increased. It is also possible for the light source and the light-sensitive elements to be arranged on different sides of the web. In this case, the sensitivity is practically reversed, meaning a light-sensitive element is impinged upon by light when blackening has occurred. In the other regions the light-sensitive elements are in the shade of the web.

The device described in EP 1 749 930 A1 is suitable for taking online measurements but, a drawback of this device is that faults in the appearance of a paper web, which, like blackening, are based on transparency effects, meaning changes of opacity, or on spots caused by drops of liquid cannot be diagnosed at all, or at least not clearly, using only one type of light, as explained above.

An appearance of a paper web is, also in keeping with deliberations so far, a visually or optically recordable state of the paper web. A fault in the appearance is a deviation from a desired appearance which can be perceived by persons or be resolved or mapped by optical measurement systems or evaluation systems and which is open, in particular, to classification by deterministic and/or statistical parameters, for example, “local blackening has occurred” and “local blackening has not occurred”. Faults in appearance are, for example, transparency effects of fibers, meaning changes of opacity, or spots caused by drops of liquid.

What is needed in the art is a method and device for recording and evaluating characteristic properties, in particular faults in appearance, of the web directly during production and to adapt the properties, preferably in real time, to a desired value, whereby the faults made accessible to a clear-cut, objective and measurement-generated evaluation and diagnosis in order to obtain control of the production and optimize the product.

### SUMMARY OF THE INVENTION

The present invention provides a method and device for the optical recording and evaluation of characteristic properties of a web containing fibers. The web can be moved, for example, the web can be transported on or with a long mesh or double mesh of a paper machine or paperboard machine. The fibers can be for example cellulose fibers. The fibers can also be fibers which are not cellulose fibers, for example chemical fibers. In particular the web can be a paper web. The paper web can move in the wet section of a paper machine.

Characteristic properties may be, for example, local faults in appearance of the web, for example transparency effects of fibers, meaning changes of opacity, or spots caused by drops of liquid, differences in mass distribution or dark spots.

The method of the present invention uses at least one light of a light source. Light is understood to be a certain spectral composition of an electromagnetic wave field which contains at least frequency components in the range visible to man or to the measurement system of the present invention. The light can also contain infrared components and/or ultraviolet components. In particular the light can contain components in the wave length range from approx. 330 to 790 nm. The method of the present invention uses in addition at least one video signal which is generated by at least one light-sensitive sensor such as a video camera. The light source and the light-sensitive sensor form a measurement system, in particular, a system that can be used to record the appearance of the web.

In addition, the method of the present invention uses an evaluation system. The evaluation system can determine the characteristic properties of interest, for example, the blackening etc., from the appearance or from description parameters derived from the appearance. Determining the characteristic parameters may be performed online, meaning directly during operation. Furthermore, the determination may take place in real time.

According to the method of the present invention two different lights are used. The light source comprises two lights. It is also possible for there to be more than one light source, for example, two or three light sources. If there is more than one light source, then it is also possible for one light source to emit only a single light.

According to the present invention, the two lights are a first light with a first color and a second light with a second color different to the first. Color is understood here to mean in particular, a band spectrum of a chromatic light. Because the first color and the second color are different, the two band spectrums of the first color and the second color have center frequencies which are clearly distinguishable for the sensor. One color may include only a single spectral line, such as can be emitted, for example, by a semiconductor laser. In the case of line spectrums, the two colors lie in frequency so far apart from each other in the visible range that the sensor is able to resolve the colored lines as different colors, or two images, each in one of the two colors, can be determined from the image signal of the sensor. A colored light may also be composed of a combination of band spectrum and line spectrum.

The two lights interact with the web containing fibers, such that a light is at least partly reflected or at least partly transmitted by the web. A light which impinges on the web and is reflected at least partly by the web is called an impinging light. A light which is transmitted at least partly by the web, meaning that it is let through the web, is called a transmitted light. In one embodiment it is possible for the two colored lights, positioned spatially one behind the other, to be radiated from the same side onto the moving web such that two impinging-light appearances in mutually different colors can be generated.

In another embodiment it is possible for the two colored lights to be radiated from different sides onto the web such that one impinging-light appearance and at least one transmitted-light appearance can be generated.

The at least one light-sensitive sensor generates the video signal from the parts of the first and second light which are received by it. From the video signal the evaluation system can determine the characteristic properties of the web containing fibers.

The advantage of the method of the present invention is that through the interaction of the web with at least two different colored lights, or the use of at least two colored lights between which the sensor can distinguish, it is possible to assign the respectively established characteristic property unmistakably to a fault in the appearance which is to be determined. The statistical frequency of false diagnoses of, for example, in particular faults in the appearance which are to be determined and corrected by control means can thus be clearly reduced. Another advantage of the method of the present invention is that it is possible to evaluate one image in the impinging light and another image in the transmitted light. If a fiber or a fiber cross-over appears dark in the impinging light but the same fiber or fiber cross-over appears bright in the transmitted light, then this is a clear indication of a transparency effect. On account of the reliable, locally assignable determination of a transparency effect it is possible, for example, given a chronologically frequent occurrence of the effect, to adjust and correct the effect, for example, zonally or locally at the local position, such as a certain point on the width of the machine.

As explained, a part of the first light reflected from the web containing fibers and a part of the second light transmitted by the web containing fibers can be received by the at least one light-sensitive sensor. Through the division into impinging light and transmitted light it is possible to determine a local fault in the appearance particularly reliably. At least a first light source emits the first color and at least a second light source emits the second color. In this way, it is very easy to arrange the one light source on the one side of the web, for example, above or below the web, and the other light source on the other side of the web. Through the division into two spatially separate light sources it is easily possible for the colored lights to be radiated from different directions onto or through the web. For example, the impinging light can be radiated from obliquely above and the transmitted light from vertically below the web. In addition at least a first sensor which is sensitive to the first color and a second sensor which is sensitive to the second color may be used. The two sensors may be sensitive, for example, to different colors or different pairs of color.

On the one hand, the doubling of the sensor hardware increases the material costs but, on the other hand, it has a favorable effect on the parallelization and real-time capability of the evaluation and the evaluation system respectively. Through the sensitivity of the two sensors to different colors or pairs of colors, for example, four different colors, it is possible for light colors which are coordinated with the characteristic property to be determined or with faults in said property to be radiated onto the web, recorded and evaluated.

In addition, the video signal of the at least one light-sensitive sensor may have at least a first color channel and a second color channel. One color channel is a data channel through which the color data, meaning data concerning the measured brightness or intensity of a certain color, for example, resolved on a pixel basis, can be transmitted from the measurement system to the evaluation system.

The at least one light-sensitive sensor may also be a color camera, for example, with at least one CCD chip. A color camera, for example, a color video camera, already contains an image-generating system such as a CCD chip, which can be used to extract the differently colored sub-images. For example, a high-grade conventional digital video camera can supply video signals with the required color component information at high speed via standardized interfaces to the evaluation system.

Because CCD sensors are only sensitive to brightness but not sensitive to color, the light signals for recording the color must be filtered, prior to conversion, into primary colors, for example, red, green and blue via color filters such as a Bayer filter or an interference filter. Each CCD pixel can be assigned its own upstream filter. Because the color filters reduce the physical resolution of the sensor it is possible, through interpolation of the brightness values of the neighboring pixels, to assign to each of the sensor's pixels its own color value such as an RGB value or CMY(K) value.

The first color may be a blue and the second color may be a red. A red, or R for short, is a light color in the wave length range from approx. 590 to 680 nm. In the CIE color space defined on the basis of a color model drawn up by the Commission Internationale de l'Éclairage (CIE), red has a wave length between 625 nm and 780 nm, which corresponds to a frequency between 380 THz and 480 THz. A red from the CIE red definition range is also an inventive red. A blue, or B for short, is a light color in the wave length range from approx. 400 to 530 nm. In the CIE color space, blue has a wave length between 430 nm and 500 nm, which corresponds to a frequency between 700 THz and 600 THz. A blue from the CIE blue definition range is also an inventive blue. The two colors can also be other colors, such as from the RGB color space, whereby R stands for a red, B for a blue and G for a green. However, pairs of colors whose colors can be distinguished without difficulty by one or more light-sensitive sensors may be selected.

For reflecting media, namely for printing apparatuses in the printing industry or for the impinging-light image of a web containing fibers, the two different colors according to the CMY color model or according to the, only slightly deviating, CMYK model may also be selected. CMY stands, as is generally known, for Cyan (C), Magenta (M), Yellow (Y). The K in CMYK stands, as is generally known, for “Key” and is consciously not intended to signify black as its purpose in printing is solely to increase the contrast.

According to the present invention it is possible, with the help of the video signal from the at least one light-sensitive sensor, to send an image for image analysis in the evaluation system. The evaluation system can communicate, for example, with a control system. The image is, for example, a digital or at least a digitizable image. With the help of the image analysis it is possible to carry out a form detection operation. A form detection operation can include the detection of a local form such as an edge and/or a vertex, which can be performed, for example, with standard image processing algorithm. The image analysis enables advantageously the fully automatic evaluation of a colored image in the evaluation system.

The image can be split into at least two, potentially three, color components such as a red component, a green component, a blue component, etc. As indicated, the splitting into colored images of different colors is advantageous for the subsequent evaluation and clear-cut classification and determination of the characteristic properties of a web's appearance.

It is possible for only a first and a second color component of the image to be drawn on for the image analysis. The components are, for example, a red component image and a blue component image. This reduces the evaluation work.

At least the first color component of the image can adopt a first color value on a pixel basis and at least the second color component of the image can adopt a second color value on a pixel basis. The color values can adopt respectively different attributes, for example, at least dark or bright. It is the brightness or intensity fluctuations caused by the effect to be investigated, such as a transparency effect or a change of opacity, which can be identified in local form in groups by the image analysis and make the individual pixels appear dark or bright. It is possible to process the bright and dark color values or, where applicable, intermediate values such as red intermediate values or blue intermediate values in the image analysis as information concerning the web's appearance.

A local form found in the image by form detection may have the first color value with a first attribute, such as dark or bright, and the second color value with a second attribute, such as dark or bright. In this way the classification and determination of the attribute of a fault of the characteristic property in the web's appearance can be performed in precise and clear-cut manner.

Conclusions can be drawn from the combination of the first and the second color value of a local form regarding the characteristic properties of the moving web containing fibers. If, for example, a red and a blue are used as the first and the second color, or if vice versa a red and a blue are used as the second and the first color, then the interpretations of the occurred effect which can be drawn from the blue value/red value combination for a discovered local form are as summarized in the following table:

| Impinging | Transmitted | |
|---|---|---|
| light, blue | light, red | |
| value | value | Interpretation |
| Dark | Dark | Dark spot, e.g. black fibers |
| Bright | Dark | Greater mass at this point of the web |
| Dark | Bright | Transparency effect, e.g. blackening |
| Bright | Bright | Smaller mass at this point of the web |

This altogether means advantageously that, in particular, transparency effects can be easily and clearly verified. It is also possible with the method of the present invention to determine the medium transparency and/or the medium mass and/or the medium dirty spot frequency (dark spots) of the web.

Hence, it is possible to build up empirical knowledge and/or control knowledge and to automatically categorize typical forms of appearance in the images. For example, one category can correspond to a hole of 24 mm² in the web and another category to a dark spot of dirt in oblong shape. The categories can either be defined as rules or be created automatically by a learning function. A combination is also conceivable.

There can, in addition, be a third light with a third color different to the first and the second color, which interacts with the web containing fibers. The third light can have, for example, green as a color. A green light corresponds to the wave length range from approx. 510 to 600 nm. In the CIE color space, green has a wave length between 520 nm and 560 nm, which corresponds to a frequency between 535 THz and 575 THz. All the wave length ranges just mentioned represent possible ranges for the third color. It is possible for the sensor to distinguish easily and clearly between the image color components given a corresponding, for example, non-overlapping selection of the light spectrums for the first, second and third.

The type of interaction between the third light and the web can be a glancing incidence, meaning the angle of incidence of the third light on the web is so flat as to form an impinging light but in the manner of a glancing light illumination in the field of vision of at least one camera. In the glancing light it is possible to detect, for example, local differences in topography of the web containing fibers, for example doctor blade streaks, mesh markings, scarring, etc. The glancing light image is thus produced from the third light, whereby the light strikes the web at a flatter angle than the first or second light which is used for the impinging light.

In addition, the influence exerted on the image by a background light, which is not emitted from the at least one light source, can be compensated. This can occur, for example, with the help of reference images. Compensation of the background light makes the evaluation of the video signals simpler and easier.

The color of the web containing fibers may be taken into account in the image analysis. The color of the fibers can be determined, for example, during interaction of the web containing fibers with a light. The light for the determination can be the first, second or third light or some other light. For example, it is possible to use, optionally in addition, a UV light to determine the color of the fibers. The determination is performed, for example, in front of variously colored backgrounds. Taking account the inherent color of the fibers makes the evaluation of the video signals even simpler and easier.

The present invention relates, in addition, to a measuring device for the optical recording and evaluation of characteristic properties, for example, faults in appearance, of a moving web containing fibers, for example cellulose fibers. For this purpose, the measuring device, of the present invention uses at least the following components: a light source, a light-sensitive sensor, such as a video camera which generates a video signal, and an evaluation system. The measuring device of the present invention implements the inventive method. The evaluation system and the video camera can also be accommodated in one housing or form one unit.

In addition there may be a first and a second method-compatible measurement system, whereby said second system cannot be disturbed by the first. It is thus possible to separately record different sides of the web, such as the upper side and the lower side of the web.

Also, it is possible for there to be a first and a second evaluation system. In this case, the first measurement system can record or determine, in cooperation with the first evaluation system, characteristic properties of a first side, for example, the upper side, of the web containing fibers, while the second measurement system can record or determine, in cooperation with the second evaluation system, potentially simultaneously with the first measurement/evaluation system, characteristic properties of another second side, for example, the lower side, of the web containing fibers. On the one hand, the duplication of systems increases the hardware requirements and hence the material costs and on the other hand, the quality of the web can be recorded and evaluated far more amply, with additional information. The two-sided recording and evaluation of the web properties may be used for fibrous products on which both sides, meaning the upper side and the lower side, are included by the user of the product in his quality assessment.

The evaluation system may determine the characteristic properties of the web containing fibers in cooperation with the measurement system in real time. In this case, “in real time” means that the determination takes place so quickly that, with the help of a feedback of physical variables imaging the characteristic properties, faults in the appearance of the web containing fibers can be corrected by control means. In short, through the real-time determination it is possible to integrate the inventive measurement/evaluation combination in an existing control system. The feedback physical variables can be, for example, an electric current or an electric voltage.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic side view of an embodiment of a measuring device implementing the method of the present invention;

FIG. 2 is a schematic side view of an embodiment of the measuring device of the present invention; and

FIG. 3 is a diagram with the selective spectral sensitivity of a CCD sensor as a function of the wave length.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

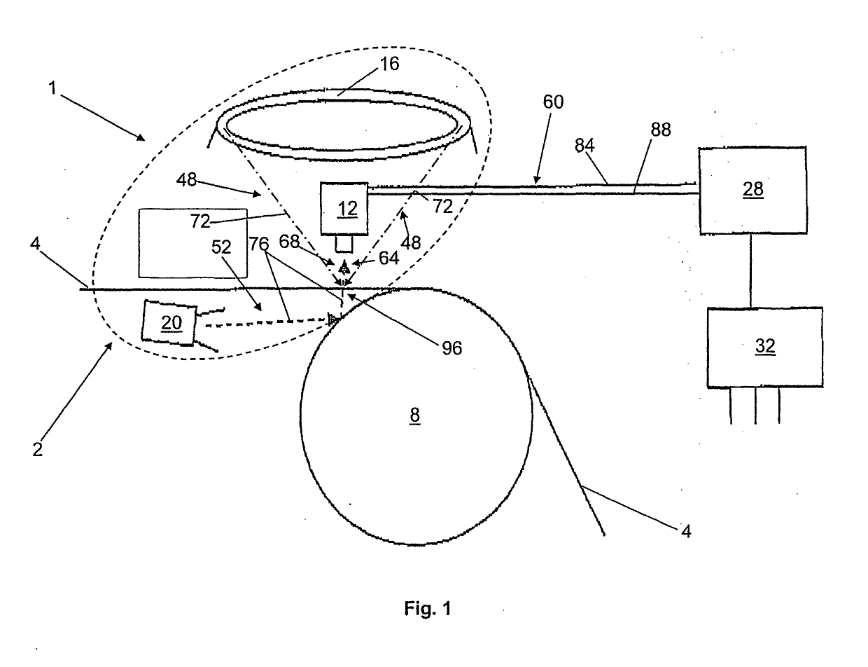

Referring now to the drawings, and more particularly to FIG. 1, there is shown an embodiment of a device 1 used to record and evaluate the local blackening of paper web 4 on a paper machine. In FIG. 1 there is shown deflecting roller 8 of the paper machine, over which the paper web is deflected and moved. As a rule, a paper machine has a plurality of rolls. There could be more inventive measuring devices near at least some of the rolls. In principle, measuring device 1 may also be in several other positions, meaning not near to a roll, for example, in different sections of the paper machine. Paper web 4 is traditionally conveyed on a long mesh. For better clarity the long mesh is not shown.

Measuring device 1 implements a method for the optical recording and evaluation of the local blackening of paper web 4 which, in this case, is a formation of a characteristic property in the sense of a fault in the appearance of paper web 4. Paper web 4 contains, as is known, cellulose fibers. Web 4 is moved in this case, meaning it moves relative to measuring device 1. It could also be vice versa, web 4 containing fibers could be stationary relative to its surroundings and the measuring device could be moved, for example, in the manner of a line-based scanning operation.

In the first embodiment, measuring device 1 uses the following components: first light 48 of first light source 16 and second light 52 of second light source 20. In this case, light source 16 is constructed in ring shape and radiates diffuse light 48. In addition, measuring device 1 uses video signal 60 which is generated by light-sensitive sensor 12, for example, a color video camera with a CCD chip.

Light source 16 is arranged above sensor 12. Sensor 12 itself is arranged a little above the upper side of web 4. The distance between sensor 12 and web 4 can be adapted to the case in question depending on the requirements or possibilities. However, the distance must be big enough to be able to generate a sharp image of the surface of web 4 from video signal 60 of sensor 12. The light-sensitive surface of sensor 12, in this case the lens of the CCD camera, faces the upper side of web 4. The diameter of ring-shaped light source 16 is big enough for light 48 emitted from it in the direction of web 4 to radiate unhindered, meaning, for example, unshaded by sensor 12, circumferentially sideways past sensor 12. Light source 20 is arranged below sensor 4. It is arranged on the same side of web 4 as roll 8. Light source 20 radiates light 52 focused onto roll 8. The surface of the roll is reflecting for light 52. Light 52 is radiated onto the surface of the roll such that the reflected part of light 52 impinges essentially perpendicular, meaning perpendicular or in an acute angle to the web plane, on the lower side of web 4. Light 52 thus passes at least partly through web 4 and can be received by sensor 12.

Light sources 16, 20 and light-sensitive sensor 12 form measurement system 2 which, in FIG. 1, is presented as a dashed-line oval border. In addition, measuring device 1 uses evaluation system 28 for evaluating video signal 60.

Light source 16, 20 includes two lights 48, 52. First light 48 has first color 72. First color 72 is symbolized in FIG. 1 by the dotted-and-dashed lines of light arrows 72. Second light 52 has second color 76, which differs from the first. Second color 76 is indicated in FIG. 1 by the dashed lines of light arrows 76.

Two lights 48, 52 interact with web 4 containing fibers. After interacting with the web, first light 48 is reflected at least partly by the surface of the web in the direction of sensor 12. Second light 52 passes at least partly through web 4 from the lower side. After interacting with the web, both lights 48, 52 are received by sensor 12.

Light-sensitive sensor 12 generates video signal 60 from the parts of first and second light 48, 52 which are received by it. From video signal 60, evaluation system 28 can determine the characteristic properties of web 4 containing fibers, in this case, the local blackening. A part of first light 48, reflected from web 4 containing fibers, and a part of second light 52, transmitted by web 4 containing fibers, are received by light-sensitive sensor 12.

First light source 16 emits first color 72 and second light source 20 emits second color 76. You could also say that first light source 16 emits a chromatic light corresponding to first color 72 and second light source 16 emits a chromatic light corresponding to second color 76.

Video signal 60 of light-sensitive sensor 12 has first and second color channel 84, 88. Color channels 84, 88 can be transmitted by separate physical means, for example, bus lines, or by a transmission method, for example, a multiplex method, on a common bus. Light-sensitive sensor 12 is a color camera which has a CCD chip.

First color 72 is a blue. Second color 76 is a red. The red, or R for short, is a light color in the wave length range from approx. 590 to 780 nm. The blue, or B for short, is a light color in the wave length range from approx. 400 to 530 nm.

Evaluation system 28 communicates with control system 32. Control system 32 can control in open-loop or closed-loop mode process parameters such as the feeding of auxiliary materials which influence the blackening.

With the help of video signal 60 from light-sensitive sensor 12, it is possible to send an image for image analysis in evaluation system 28. The image is a digital image. With the help of the image analysis it is possible to carry out a form detection operation, here the detection of local form 96, in real time. Local form 96 has in this case, inasmuch as the transparency effect of the blackening is to be determined, the form of mutually crossing fibers or transparent fiber lines.

The image, which can be transported by video signal 60, can be split into two color components, for example, a red component and a blue component. As such, only a first and a second color component of the image are drawn on for the image analysis.

The first color component of the image adopts a first color value on a pixel basis and the second color component of the image adopts a second color value. The color values can adopt respectively different attributes, for example, dark or bright. Local form 96 found in the image by form detection has the first color value with a first attribute, in this case dark or bright, and the second color value with a second attribute, in this case likewise dark or bright. Conclusions can be drawn from the combination of the first and the second color value, for example, the group of colors blue, red and green, of local form 96 regarding the characteristic properties, in this case the local blackening, of moving web 4 containing fibers. For this purpose, the values of at least two color values are combined.

The influence exerted on the image by a background light, which is not emitted from one of light sources 16, 20, can be compensated. This compensation of background light is performed with the help of reference images.

The color of web 4 containing fibers is taken into account in the image analysis. The color of web 4 containing fibers is determined during an interaction of web 4 containing fibers with the first and second light 48, 52 and in addition a UV light, and is done so namely in front of variously colored backgrounds. The important point with the images produced to determine the web color is not so much local patterns but the average color at the measurement location.

Measuring device 1 implements the method of the present invention. Evaluation system 28 determines the characteristic properties of web 4 containing fibers, for example, the local blackening, in cooperation with measurement system 2 in real time. This means that the local blackening is determined on the surface of web 4 moving past sensor 12 so quickly that, with the help of a feedback of physical variables imaging the characteristic properties, for example, an electric current or an electric voltage, faults in the appearance of web 4 containing fibers can be corrected by control means. The faults, meaning the local blackening, can be corrected in this case by control system 32.

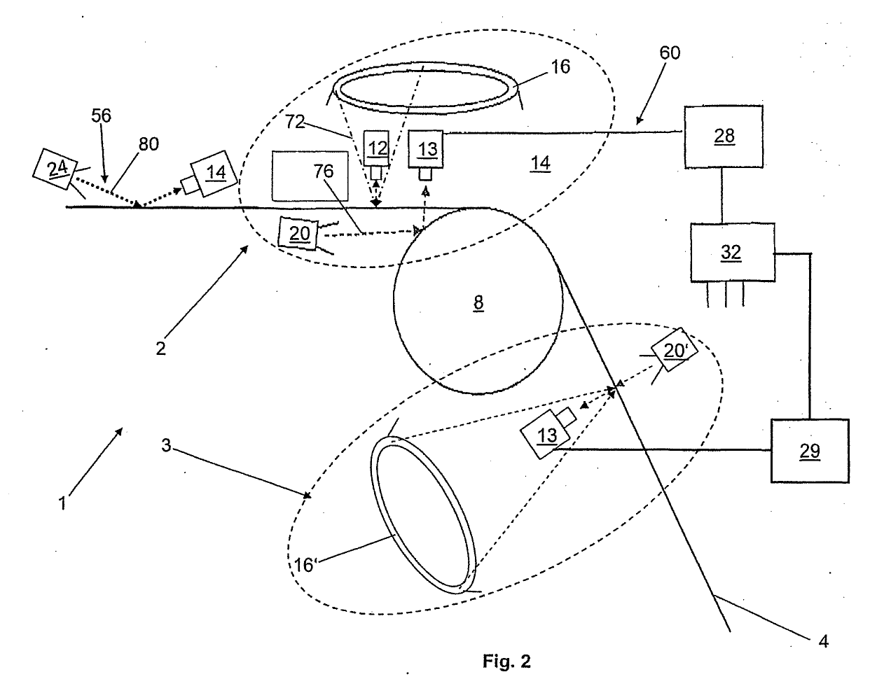

A second embodiment of measuring device 1, presented in FIG. 2, is an extended construction of the first embodiment described above. Unlike the first embodiment, use is made of first sensor 12 which is sensitive to first color 72 and a second sensor 13 which is sensitive to second color 76. Paper fibers are very thin (thinner than 0.1 mm) and the production speed of the web is very high (higher than 100 km/h). Therefore, the synchronization of the two cameras has to meet exacting demands. In this case, there is in addition third light 56 with third color 80 different to the first and the second color, which interacts with web 4 containing fibers. Third light 56 is emitted in this case by third light source 24. Third color 80 is a green from the wave length range from approx. 510 to 600 nm.

Light 56 glances web 4 in a flat angle. You can speak of a type of glancing light illumination. The light is received, after glancing, by third light-sensitive sensor 14. The image signal from glancing light sensor 14 can be evaluated likewise in evaluation system 28. The glancing light must be flat enough to be able to detect local differences in topography of web 4 containing fibers, for example doctor blade streaks, mesh markings, scarring, which are particularly well visible in the glancing light. Ideally glancing light 56 comes uniformly from all directions. A light incidence orientation of 90° to the anticipated defect is optimal for detecting special defects (e.g. doctor blade streaks). An evaluation of edges and forms, which appear green, permits additional conclusions to be drawn concerning the topography, namely differences in thickness caused by the topography of the side of the paper web facing the camera. This means it is possible to clarify whether differences in topography, for example, doctor blade streaks, have led to the different local distribution of mass.

Sensor 13 is connected, as shown in FIG. 2, to evaluation unit 28 via a bus line which transports video signal 60. Sensors 12 and 14 are connected likewise via corresponding bus lines to evaluation system 28, the lines not being shown here for the sake of clarity.

The second embodiment of measuring device 1 includes first and second method-compatible measurement system 2, 3, whereby the second system cannot be disturbed by the first. First measurement system 2 is arranged, in this case, as with the first embodiment, in front of the roll in the direction of movement of web 4, while second measurement system 3, which is additional compared to the first embodiment, is arranged behind the roll. The second embodiment of measuring device 1 includes, in addition, first and second evaluation system 28, 29. Both evaluation systems are connected to control system 32.

First measurement system 2 records and determines, in cooperation with first evaluation system 28, the local blackening of the upper side of web 4 containing fibers, while second measurement system 3 records and determines, in cooperation with second evaluation system 29, an additional characteristic property, namely of the lower side of web 4 containing fibers. Measurement system 3 determines in this case likewise the local blackening, namely that of the lower side of web 4.

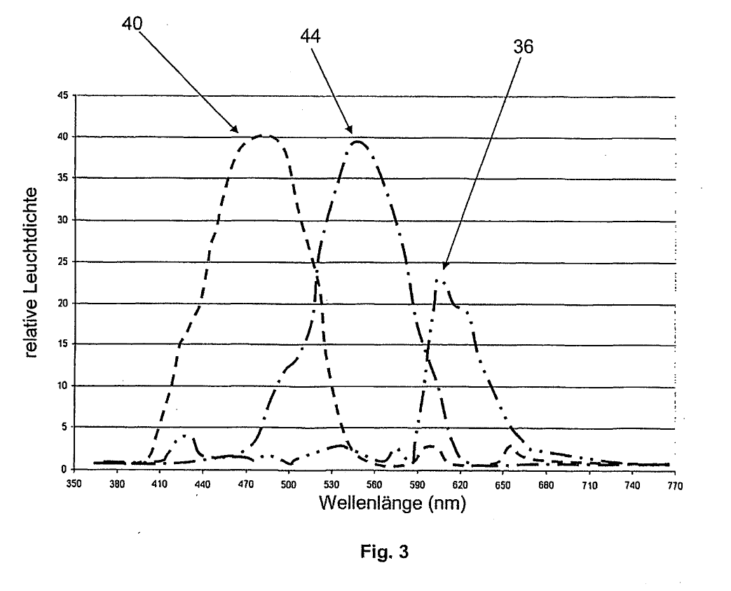

Presented in FIG. 3 is a typical spectrum of a CCD camera with a recorded RGB image. The diagram shows first, second and third spectral sensor characteristics 36, 44, 40. The unit of the ordinates is the relative luminance. The relative luminance is based, as is generally known, on the photometric definition of luminance whose SI unit is cd/m2. Contrary to luminance, the values of relative luminance are normalized to a range from 1 to 100 for a reference white. All three sensor characteristics are available in a modern video camera. Hence, it is possible to selectively evaluate the three above described colors, namely red, green and blue. Blue and red are very easy to separate using a suitable color selection of the illumination. The green light, for example, between approx. 560 and 590 nm, triggers only the green sensor of the camera.

In summary it can thus be said: Measuring device 1 represents an online measuring device. The inventive method and the measuring device 1 make use of the fact that faults in the appearance of a fibrous web, such that are based on transparency effects, are perceived differently in impinging light than in transmitted light. The faults include blackening, meaning transparency effects of fibers, and spots caused by drops of liquid. At least two illuminations are used because the described types of fault cannot be clearly diagnosed with only one type of illumination. In the case of blackening, a dark fiber and a semi-transparent fiber indicative of blackening are practically identical, for example, in impinging light. The same specimen is recorded therefore with two images: one image in impinging light and another image in transmitted light. If a paper fiber appears dark in the impinging light but the same fiber appears bright in the transmitted light, then this is a clear indication of a transparency effect. Another possibility would be to use impinging light and two different backgrounds (for example black and white). In this way it is also possible to detect local transparency effects (changes of opacity).

The method and the measuring device permit the online measurement of transparency effects in web 4 and the assignment of the transparency effects to causes, for example, blackening and/or mass distribution, by only one camera during the production of web 4. The additional measurement of topographical properties of web 4 and in particular the thickness of the web is possible.

The cameras are best arranged such that the distance between the camera and the web is constant. This can be done by recording the images at a location where the movements of the paper web in z direction are very small. It is expedient, for example, to record the images in the direct vicinity of a roll surface. Or the web is fixed in its position relative to the camera at the measuring point by web stabilizers. Or the camera is located on a measurement structure which hovers at a defined height above the paper web, for example an air cushion.

It must be ensured in particular that the web remains within the depth of focus of the camera lens. Hence, it is possible for the camera to be permanently installed at one point of the paper web. Alternatively, numerous cameras can be arranged in the cross machine direction of the paper web. It is also possible however for a camera with illumination to be arranged on a traversing measurement carriage.

The image recording time, characterized by variables such as flash speed or shutter speed, must be selected such that the local objects of interest on a moving web are recorded sharply enough for evaluation. In the case of paper fibers, an image recording speed of 1 μsec or less is desirable.

The advantages of the present invention are, on the one hand, that transparency effects can be localized and, on the other hand, that fluctuations of mass can be distinguished from fluctuations of thickness. This means that differences in the opacity of the fibrous web can be differentiated according to their origin. Furthermore, it is also possible to determine local differences of thickness and topographical structures. Depending on the determined paper property, which for those skilled in the art is the actual value when the invention is integrated in a control system, it is thus possible to trigger actions for correcting the paper property to a desired value. This can be done automatically or by an operator.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF REFERENCE NUMERALS

1 measuring device
2 (first) measurement system
3 second measurement system
4 web containing fibers
8 deflecting roller
12 first light-sensitive sensor
13 second light-sensitive sensor
14 third light-sensitive sensor
16 first light source
20 second light source
24 third light source
28 (first) evaluation system
29 second evaluation system
32 control system
36 first spectral sensor characteristic
40 second spectral sensor characteristic
44 third spectral sensor characteristic
48 first light
52 second light
56 third light
60 video signal
64 reflected part
68 transmitted part
72 first color
76 second color
80 third color
84 first color channel
88 second color channel
96 local form

What is claimed is:

1. Method for optically recording and evaluating characteristic properties of a moving fibrous web, the method comprising the steps of:
causing at least one first light source having two lights to interact with the web, said two lights being a first light having a first color and a second light having a second color different from said first color;
forming a measurement system with said at least one first light source and at least one light-sensitive sensor;
generating a video signal with said at least one light-sensitive sensor from parts of said first light and said second light; and
determining the characteristic properties of the fibrous web from said signal with an evaluation system.

2. The method of claim 1, wherein said at least one light-sensitive sensor is a video camera.

3. The method according to claim 2, further comprising the step of receiving a part of said first light reflected from the web and a part of said second light transmitted by the web by said at least one light-sensitive sensor.

4. The method according to claim 3, further comprising at least one second light source, said at least one first light source emitting a first color and said at least one second light source emitting a second color.

5. The method according to claim 4, wherein said at least one light-sensitive sensor includes at least one first sensor sensitive to said first color and at least one second sensor sensitive to said second color.

6. The method according to claim 5, wherein said video signal has at least one first channel and at least one second channel.

7. The method according to claim 6, wherein said at least one light-sensitive sensor is a color camera.

8. The method according to claim 7, wherein said camera has a CCD chip.

9. The method according to claim 8, wherein said first color is blue and said second color is red.

10. The method according to claim 9, further comprising the step of sending an image being one of a digital image and a digitizable image to said evaluation system with said video signal, analyzing said image with said evaluation system, and carrying out a form detection operation in real time.

11. The method according to claim 10, wherein said detection operation includes detection of a local form.

12. The method according to claim 11, further comprising the step of splitting said image into at least two color components.

13. The method according to claim 12, wherein said image is split into at least three color components.

14. The method according to claim 13, wherein said at least two color components include a first color component and a second color component, said image analysis step including drawing on only said first color component and said second color component.

15. The method according to claim 14, further comprising the step of at least said first color component adopting a first color value on a pixel basis and at least said second color component adopting a second color value on a pixel basis, said first color value and said second color value adopting different attributes.

16. The method according to claim 15, wherein said first attribute and said second attribute are each one of dark and bright.

17. The method according to claim 16, wherein said local form has said first color value having a first attribute and said second color value having a second attribute.

18. The method according to claim 17, wherein said first attribute is one of dark and bright and said second attribute is the other of one of dark and bright.

19. The method according to claim 18, further comprising the step of drawing conclusions from a combination of said first color value and said second color value regarding the characteristic properties of the moving fibrous web.

20. The method according to claim 19, further comprising the step of causing a third light having a third color different from said first color and said second color to glance and interact with the fibrous web and detecting differences in a topography of the fibrous web.

21. The method according to claim 20, wherein said differences in said topography of the fibrous web are at least one of doctor blade streaks, mesh markings and scarring.

22. The method according to claim 20, wherein said third color is green.

23. The method according to claim 22, further comprising the step of compensating for an influence exerted on said image by a background light not emitted from said at least one light source.

24. The method according to claim 23, further comprising the step of using reference images to compensate for said influence exerted on said image by said background light.

25. The method according to claim 24, said image analysis step further including accounting for a color of the fibrous web.

26. The method according to claim 25, further comprising the step of determining said color of the fibrous web during an interaction of the fibrous web with at least one of said first light, said second light, said third light and a UV light.

27. The method according to claim 26, wherein said color of the fibrous web is determined in front of a plurality of different color backgrounds.

28. A measuring device for optically recording and evaluating characteristic properties of a moving fibrous web, the measuring device comprising:
a first light source having two lights configured to interact with the fibrous web, said two lights being a first light having a first color and a second light having a second color different from said first color;
at least one light-sensitive sensor configured to generate a video signal from parts of said first light and said second light, wherein said at least one first source and said at least one light-sensitive sensor are configured to form a measurement system; and
an evaluation system configured to determine the characteristic properties of the fibrous web from said video signal.

29. The measuring device according to claim 28, wherein said light-sensitive sensor is a video camera.

30. The measuring device according to claim 29, wherein said measurement system includes a first measurement system and a second measurement system independent of said first measurement system and said evaluation system includes a first evaluation system and a second evaluation system, said first measurement system and said first evaluation system configured to record and determine the characteristic properties of an upper side of the web and said second measurement system and said second evaluation system are configured to record and determine the characteristic properties of a lower side of the web.

31. The measuring device according to claim 29, including an electronic controller, and wherein said evaluation system and said measurement system are configured to determine the characteristics of the fibrous web in real time using feedback to said controller such that faults in said characteristic properties can be corrected.
